(19) United States
(12) Patent Application Publication
(10) Pub. No.: US 2007/0068451 A1
(43) Pub. Date: Mar. 29, 2007

(54) METHOD FOR FORMING A RESIST PATTERN

(76) Inventor: Yoichi Nomura, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/533,428

(22) Filed: Sep. 20, 2006

(30) Foreign Application Priority Data
Sep. 29, 2005 (JP) 2005-283850

(51) Int. Cl. B05C 13/02

(52) U.S. Cl. 118/58

(57) ABSTRACT

Pattern deduction processes of prior art include, after applying a solution reacting with a resist pattern on a surface of the resist pattern, a step of heating a substrate to accelerate the reaction between the resist pattern and the applied film. However, heating for the acceleration of reaction necessarily accompanies conveyance of substrates onto a hot plate. The present invention provides an application apparatus which is provided with a temperature raising means for raising a temperature of the resist pattern reduction material in the vicinity of a nozzle for dropping the resist pattern reduction material.

### BACKGROUND OF THE INVENTION

1. Field of the Invention

The present invention relates to a resist application apparatus and a method for forming a resist pattern using the same.

2. Description of the Related Art

With the tendency of high integration of semiconductor devices and downsize of chip sizes lately, semiconductor devices having a minimum wiring line width of 65 nm have currently been put to practical use. Since such a tendency of providing a finer wiring line is expected to continue in the future, there is an increasing need of forming a fine pattern.

For forming a fine wiring line, exposure techniques of optical lithography, such as KrF laser exposure and ArF laser exposure, are primarily used currently when the line width of 100 nm or more is required to be formed. On the other hand, in order to obtain a fine pattern having a line width of 100 nm or less, a new exposure technique of optical lithography, such as F₂ laser exposure, has recently been adopted.

Further, various other exposure techniques, such as electron beam (EB) exposure techniques, X-ray exposure techniques and EUV exposure techniques have also been suggested.

In addition to a direct-writing EB exposure technique now underway, EB steppers for adopting a 4-time reduction exposure technique and low-energy electron beam lithography techniques have also been disclosed as the EB exposure techniques. The low-energy electron beam lithography technique is a technique in which proximity exposure is performed through a stencil mask of the same magnification using accelerating voltage of about 2 keV, and which has been developed as a potential technique for forming a semiconductor pattern having a line width of 100 nm or below.

However, when an exposure wavelength become shorter, a resist material suitable for the shorter wavelength is required. This creates a problem, for example, that such a resist material cannot be readily supplied. In addition, the use of a shorter exposure wavelength, per se, has a limitation. Also, other problems have often arisen, for example, that an etching resistance exhibited by a new photoresist material is poor.

In order to improve these problems, techniques for reducing a resist pattern formed are disclosed in Japanese Patent Application Laid-Open Nos. 2001-281886, 2004-205699 and 10-073927.

The technique disclosed in Japanese Patent Application Laid-Open No. 2001-281886 is to reduce a size of a resist pattern formed, and the techniques disclosed in Japanese Patent Application Laid-Open Nos. 2004-205699 and 10-73927 are to enlarge a size of a resist pattern formed to reduce a size of spacing between the resist patterns.

The technique disclosed in Japanese Patent Application Laid-Open No. 2001-281886 is described below with reference to FIG. 3.

A chemically-amplified positive resist is applied on a substrate 1 to form a photoresist film 2 (see FIG. 3(1)). Subsequently, the photoresist film 2 is exposed (as shown by arrows) using a photomask 3 to form a latent image pattern 4 in an unexposed portion (see FIG. 3(2)). The resist-applied post-exposure surface is developed with an alkaline developer consisting of an alkaline solution to dissolve the exposed portion. The resultant is washed with pure water. Thereby, a positive resist pattern 5 is formed (see FIG. 3(3)).

The steps shown in FIGS. 3(1) to 3(3) may be performed using a conventionally chemically-amplified positive resist, so that exposure and development are carried out under conventional conditions. The principle of forming such a positive resist pattern is as follows. A chemically-amplified positive resist consists of a radiation-sensitive positive resin composition, containing a radiation-sensitive acid generating agent and a resin which is alkali-insoluble or hardly soluble in with an acidic group therein being protected by an acid-dissociative group R and turns to alkali-soluble upon dissociation of the acid-dissociative group R (this resin is hereinafter referred to as an acid dissociative group containing resin (I)). When the chemically-amplified positive resist is exposed, acid (expressed by H⁺) is generated from the radiation-sensitive acid generating agent in the resist. The generated acid acts on the protecting group R of the acid dissociative group containing resin (I) to make the acid dissociative group containing resin (I) turn to alkali-soluble. Then, when the resist which includes a resin (II) that has been turned to alkali-soluble is developed by an alkaline developer, the alkali-soluble resin (II) dissolves into the solution and is removed, so that a latent image becomes apparent.

Subsequently, a resist pattern reduction material containing a water-soluble resin which is acidic with pH of below 7, preferably with pH of 1 to 4, is applied on a surface of the resist pattern 5 (typically, applied and then dried) to form a coated film 6 thereon consisting of the resist pattern reduction material (see FIG. 3(4)).

Any water-soluble resin which is acidic, neutral and basic may be used. Examples of the resin include poly(meth)acrylic acid and its derivatives, polyvinyl alcohol and its derivatives, polymethylvinylether, polyethylvinylether, polyhydroxystyrene and its derivatives, polyethyleneglycol, poly(maleic acid-co-vinyl ether), polyvinyl acetal, polyvinylpyrrolidone, polyethyleneimine, polyethylene oxide, poly(styrene-co-maleic anhydride), polyvinylamine, polyallylamine, water-soluble resins containing a oxazoline group, water-soluble melamine resins, water-soluble urea resins, alkyd resins, sulfonamide resins, copolymers containing 10 mol% or more of repeating units derived from (meth)acrylic acid, copolymers containing 5 mol% or more of repeating units derived from 2-methacrylamide-2-methylpropane sulfonic acid, and water-soluble salts thereof. Among these, water-soluble resins, such as polyacrylic acid, polyvinyl alcohol, polyvinylpyrrolidone, poly(maleic acid-co-vinyl ether), copolymers containing 10 mol% or more of repeating units derived from acrylic acid, copolymers containing 5 mol% or more of repeating units derived from 2-methacrylamide-2-methylpropane sulfonic acid, and water-soluble salts thereof, are preferable. The water-soluble resin can be used alone or in combination of two or more kinds.

As described later, the resist pattern reduction material is used as an applying liquid to be applied on a surface of a resist pattern formed on a substrate to form a coated film thereon. When the resist pattern reduction material is used, the solid content therein may be, for example, 1 to 20 wt %. A solvent is mixed so as to obtain the required concentration. Basically, water is used as a solvent, but other solvents, such as a mixture of water and an organic solvent which is compatible with water may be used (note that the amount of an organic solvent should be sufficiently small (typically 10 wt % or below) as not to corrode the resist pattern). Examples of an organic solvent which is compatible with water include methanol, ethanol, isopropanol, ethyl lactate, and propylene glycol monomethyl ether.

Any additive, such as a surfactant and a pH adjustor, may optionally be formulated, as required, into the resist pattern reduction material. These additives are used within a rage of not ruining the object and effects of the present invention.

Any surfactant that will not be evaporated or sublimed by heat may be used, but an anionic surfactant may be preferable. Examples of an anionic surfactant include alkyl carboxylic acids, alkyl sulfonic acids, fluoroalkyl carboxylic acids, fluoroalkyl sulfonic acids, and salts thereof. Among these, fluoroalkyl carboxylic acids, fluoroalkyl sulfonic acids, and salts thereof, which have high surface activating performance, are preferable. In particular, perfluorooctanic acids, perfluorooctane sulfonic acids, and ammonium salts thereof are more preferable. When mixing a surfactant, the amount depends, for example, on the acidity of the resist pattern reduction material and a kind of the surfactant, but preferably the amount should be about 1 to 100 parts by weight for 100 parts by weight of the water-soluble resin. The surfactant mentioned above can be used alone or in combination of two or more kinds.

Due to the effects of the acid contained in the acidic coating film 6, a surface layer of the alkali-insoluble resist pattern 5 turns to an alkali-soluble layer. The surface layer after turning to alkali-soluble is indicated as a surface layer 7, and the resist pattern including the surface layer 7 is indicated as a resist pattern 5′ (see FIG. 3(5)).

The process by which the surface layer of the alkali-insoluble resist pattern 5 turns to alkali-soluble may be performed by simply leaving the resist pattern 5 provided with the acidic coated film 6, or by taking an accelerating action for the surface layer, such as heating. Of course, these actions can be taken in combination. Preferable treatment conditions in which the surface layer of the alkali-insoluble resist pattern 5 turns to an alkali-soluble layer, typically, time to be left, and temperature and time of heating, can generally be adjusted according to an intended reducing ratio (or line width), although this depends, for example, on the properties of a reduction material (acidity, in particular) and the kind of an acid-dissociative group. For example, heating temperature is in the range of 50 to 200° C., and time to be left is in the range of 1 to 120 minutes. Examples of a heating means include a hot plate and an oven.

The resist pattern 5′ together with the acidic coated film 6 formed on the surface thereof is then treated with an alkaline solution. Through this process, the acidic coated film 6 and the resist pattern surface layer 7 thereunder, which has been turned to alkali-soluble, are dissolved in the solution and removed, to obtain a fine resist pattern in which a line width has been reduced (see FIG. 3(6)).

It should be noted that the temperature during the processing with an alkaline solution is typically 15 to 70° C., preferably 20 to 30° C. The processing time can be determined appropriately. The same alkaline developer used for developing the chemically-amplified positive resist can be used as the alkaline-solution. After the treatment with the alkaline solution, the resist pattern is typically washed with water.

Next, the technique disclosed in Japanese Patent Application Laid-Open No. 2004-205699 is described below with reference to FIG. 4.

A chemically-amplified positive resist, which contains silicon, is applied on a substrate 1 to form a photoresist film 2 (see FIG. 4(1)). Subsequently, the photoresist film 2 is exposed (as shown by arrows) using a photomask 3 to form a latent image pattern 4 in an unexposed portion (see FIG. 4(2)). The resist-applied post-exposure surface is developed with an alkaline developer consisting of an alkaline solution to dissolve the exposed portion. The resultant is washed with pure water. Hereby, a positive resist pattern 5 is formed (see FIG. 4(3)).

Subsequently, a patterning material (water-soluble silicone) containing a water-soluble silicone resin as a main component is applied on a surface of the resist pattern 5 (typically, applied and then dried) to form a coated film 6′ thereon consisting of the patterning material (see FIG. 4(4)).

The patterning material contains a water-soluble silicone resin as a main component as mentioned above, which typically contains water, and preferably, a crosslinking agent.

Preferably, the water-soluble silicone resin may be obtained by hydrolysis and condensation of a silicon compound expressed by the following formula (1):
R¹ₙR²ₘSiX₄₋ₙ₋ₘ (1)

where R¹ represents an organic group including a hydroxy group, an epoxy group, an amino group, or an isocyanate group; R² represents an alkyl group having 1 to 4 carbons, a fluoridated alkyl group, or an aryl group having 6 to 10 carbons; n represents 1 or 2; m represents 0 or 1; and n+m equals to 1 or 2. X represents a halogen atom, a hydroxy group, or an alkoxy group having 1 to 4 carbons.

Examples of R¹, the organic group including a hydroxy group, an epoxy group, an amino group, or an isocyanate group, include organic groups in which a portion of hydrogen atoms of a monovalent hydrocarbon group, such as a linear, branched or cyclic (including bridged cyclic) alkyl group having 1 to 20 carbons, in particular, having 3 to 12 carbons, and an aryl group having 6 to 20 carbons, is substituted by a hydroxy group, an epoxy group, an amino group, or an isocyanate group. In this case, the monovalent hydrocarbon group such as an alkyl group may be intervened, for example, by an oxygen atom, an NH group, an N(CH₃) group, an N(C₆H₅) group, a CO group, and a COO group. Alternatively, a portion of the hydrogen atoms of the monovalent hydrocarbon group such as an alkyl group may be substituted, for example, by a halogen atom such as Cl and F, or by an alkoxy group, other than a hydroxy group, an epoxy group, an amino group or an isocyanate group.

Examples of R² include a methyl group, an ethyl group, a propyl group, an isopropyl group, a butyl group, an isobutyl group, a tert-butyl group, a group in which a portion or all of the hydrogen atoms thereof is substituted by fluorine atoms; a phenyl group, a tolyl group, and an xylyl group.

By heating the substrate in which the coated film 6′ consisting of the patterning material having the water-soluble silicone resin as a main component is formed on the resist pattern, a surface layer 7′ consisting of a crosslinking layer of a silicone resin is formed on the surface of the resist pattern. The resist pattern including the surface layer 7′ consisting of the crosslinking layer of a silicone resin is indicated by a resist pattern 5″ (see FIG. 4(5)).

In performing the processes of forming the surface layer 7′ consisting of the crosslinking layer of a silicone resin on the surface of the resist pattern, it is preferable to heat and bake the substrate to accelerate the crosslinking reaction. The baking is carried out at a temperature of 40 to 120° C. for 10 to 300 seconds. The thickness of the crosslinking layer can be controlled by adjusting the baking temperature and time.

The resultant is then cooled, and the uncrosslinked patterning material having a water-soluble silicone as a main component is washed with water for removal, to obtain a fine resist pattern 8′ in which a size of spacing therebetween has been reduced (see FIG. 4(6)).

The technique disclosed in Japanese Patent Application Laid-Open No. 10-73927 is one for attaining crosslinking with resist as disclosed in Japanese Patent Application Laid-Open No. 2004-205699, however, uses a conventional chemically-amplified resist instead of a silicon-containing resist, and uses a patterning material containing a water-soluble resin composition and a water-soluble crosslinking agent instead of the material containing silicon.

The technique disclosed in Japanese Patent Application Laid-Open No. 2001-281886 is intended to reduce a size of a resist pattern, and thus can be used, for example, in reducing a width of a wiring line. The techniques disclosed in Japanese Patent Application Laid-Open No. 2004-205699 and Japanese Patent Application Laid-Open No. 10-73927 are intended to reduce a size of spacing between resist patterns by increasing a size of the resist pattern, and thus can be used, for example, in forming openings in resist to obtain smaller contact holes.

Applying a chemically-amplified resist on a substrate, the development and washing with water as illustrated in FIGS. 3(1) to 3(3) and FIGS. 4(1) to 4(3) can be performed using a cup-shaped application apparatus shown in FIG. 2. In the application apparatus shown in FIG. 2(1), a substrate 13 is mounted on a substrate mounting table 12 which is integrated with a rotating shaft 11 and an applying solution is dropped from an applying nozzle 14 onto the substrate 13 so that the solution is applied on the substrate.

In case of applying a chemically-amplified photoresist, a predetermined amount of photoresist 15 is dropped from the nozzle onto the substrate 13. Then, the rotating shaft 11 is rotated in a direction, for example, shown by an arrow in the figure at a low number of revolution by a motor (not shown) connected to the rotating shaft 11, so that the substrate 13 is covered with the photoresist 15. The number of revolutions is then increased so that the substrate is covered with the photoresist with a uniform thickness and that excessive photoresist 15 is flicked away from the substrate. In this regard, a cup 10 is formed to cover the substrate 13 and a portion of the rotating shaft 11, whereby the apparatus is prevented from being contaminated by the photoresist 15 which is scattered outside being flicked away from the substrate 13.

In performing the development, a nozzle 14′ as shown in FIG. 2(2) is used to drop a developer, while the rotating shaft is rotated during the development at a relatively low speed. Washing with water is often carried out using the nozzle 14′ shown in FIG. 2(2) to drop pure water for washing, while the rotating shaft is rotated at a relatively medium speed.

It should be noted that, as shown in FIG. 2(3), the nozzle 14 or 14′ may have to be located over the substrate only when the solution is dropped onto the substrate. Thus, the nozzle is moved to a center of the substrate by a moving mechanism not shown when dropping the solution, and otherwise is withdrawn to a position distanced from the substrate which is disposed in the cup.

When a solution is dropped from a plurality of openings as possessed by the nozzle 14′, the openings may only have to be linearly arranged, which allows the shape of the nozzle to be rectangular when looked down from above.

The technique of pattern reduction process disclosed in each of Japanese Patent Application Laid-Open Nos. 2001-281886, 2004-205699 and 10-73927 has a step of heating the substrate to accelerate reaction between the resist pattern and the applied film, after applying a solution reacting with the resist pattern on a surface of the resist pattern.

The applying step can be carried out using the conventional application apparatus as shown in FIG. 2, however, heating for the acceleration of reaction necessarily accompanies conveyance of substrates onto a hot plate.

In the conventional pattern reduction process, therefore, heating has to be carried out in a separate apparatus. Specifically, a step has been required in which the substrate, being applied with a solution reacting with a resist pattern thereon, is conveyed out of the application apparatus to another apparatus, for example, a hot plate or a baking furnace, to carry out heating and then conveyed back to the application apparatus to remove the solution reacting with the resist pattern.

In a factory where semiconductor devices are manufactured on mass production lines, 10 to 30 substrates as one set are sequentially processed through individual steps. A resist pattern is required to be produced in such a manner that the same size is ensured between the individual sets and thus between the individual substrates constituting each set. Therefore, steps of applying a solution reacting with the resist pattern, conveying the substrates, heating the substrates, conveying the substrates back and removing the solution reacting with the resist pattern from the substrates, have to be performed in a certain period of time. To this end, it is required that two application apparatuses are made ready, and a hot plate, for example, is also made ready in the vicinities of the application apparatuses to carry out the processing procedures taking into consideration of the difference between the time required for applying the solution reacting with the resist pattern and the time required for removing the solution reacting with the resist pattern. Thus, a separate processing space and a separate apparatus have to be provided.

### SUMMARY OF THE INVENTION

The present invention provides a method for forming a resist pattern, comprising the steps of: conveying a substrate, on which the resist pattern with a first size is formed, to a substrate mounting table of an application apparatus; raising a temperature of a resist pattern reduction material supplied to the application apparatus in the vicinity of an opening of a nozzle for dropping the resist pattern reduction material in the application apparatus; dropping the temperature-raised resist pattern reduction material onto the resist pattern of the substrate to be applied; forming the transformed layer between the resist pattern and the applied resist pattern reduction material; and reducing the resist pattern to that with a second size by removing the resist pattern reduction material, wherein the steps of from conveying the substrate to reducing the resist pattern are performed without transferring the substrate out of the application apparatus. It is preferable that the method for forming a resist pattern further comprises a step of raising a temperature of the substrate conveyed to the substrate mounting table of the application apparatus to the same temperature as that of the temperature-raised resist pattern reduction material, prior to the step of dropping the resist pattern reduction material. It is preferable that in the step of raising the temperature of the resist pattern reduction material of the method for forming a resist pattern, the temperature is raised to the reaction promoted temperature which is higher than the room temperature.

Further, the present invention provides an application apparatus for forming a resist pattern which reduces the resist pattern, comprising: a substrate mounting table integrated with a rotating shaft for mounting a substrate thereon; a rotation means for rotating the substrate mounted on the substrate mounting table by rotating the rotating shaft; a first nozzle for dropping the resist pattern reduction material onto the substrate; a cup extending along the axial direction of the rotating shaft so as to cover at least the substrate and the rotating shaft, a temperature raising means for raising a temperature of the resist pattern reduction material in the vicinity of the openings; and a second nozzle for supplying a remover liquid for removing the resist pattern reduction material on the substrate; wherein the first nozzle for dropping the resist pattern reduction material onto the substrate has a plurality of openings arranged in a row; the plurality of openings are arranged such that the plurality of openings traverse substantially a center of the substrate mounted on the substrate mounting table; and a distance L across the plurality of openings and a diameter R of the substrate satisfy a relation of 0.8R≦L≦R.

According to the present invention, steps for reducing a resist pattern can be executed using only an application apparatus for applying a solution of a resist or the like, by dropping a pattern reduction material onto the resist pattern after formation of a resist pattern, with temperature of the material having been raised up to the temperature for accelerating reaction. Thus, the steps for conveying the substrate out of and back to the application apparatus can be omitted. In addition, since no apparatus for heating the substrate is required, space can be saved.

### BRIEF DESCRIPTION OF THE DRAWINGS

FIG. 1 is a schematic cross sectional view of a nozzle according to the present invention;

FIGS. 2 are schematic views showing a structure of an application apparatus;

FIGS. 3 are schematic cross sectional view showing steps for reducing a size of a resist pattern; and

FIGS. 4 are schematic cross sectional view showing steps for reducing a size of spacing between resist patterns.

### DETAILED DESCRIPTION OF THE PREFERRED EMBODIMENTS

The present invention has been made to reduce a size of a resist pattern formed, or to reduce a size of spacing between resist patterns, after the resist pattern was formed. A conventional chemically-amplified positive resist pattern can be used.

In case of reducing a size of a resist pattern, an acidic solution containing a water-soluble resin as a resist pattern reduction material is applied on the resist pattern. Acid in the resist pattern reduction material then reacts with the resist pattern to form an alkali-soluble transformed layer on a surface of the resist pattern which is alkali-insoluble. Thus, the resist pattern reduction material and the transformed layer can be removed using an alkaline solution (alkaline developer) to reduce the size of the resist pattern.

On the other hand, in case of reducing a size of spacing between resist patterns, a resist pattern reduction material containing a water-soluble silicone resin as a main component is applied on the resist pattern to form a surface layer consisting of a crosslinking layer of the silicone resin on a surface of the resist pattern. Uncrosslinked water-soluble silicone resin can then be removed by washing with water.

Reaction between the resist pattern and the resist pattern reduction material is required to be accelerated by heating, in both of the cases where the size of the resist pattern is reduced, and where a size of spacing between resist patterns is reduced.

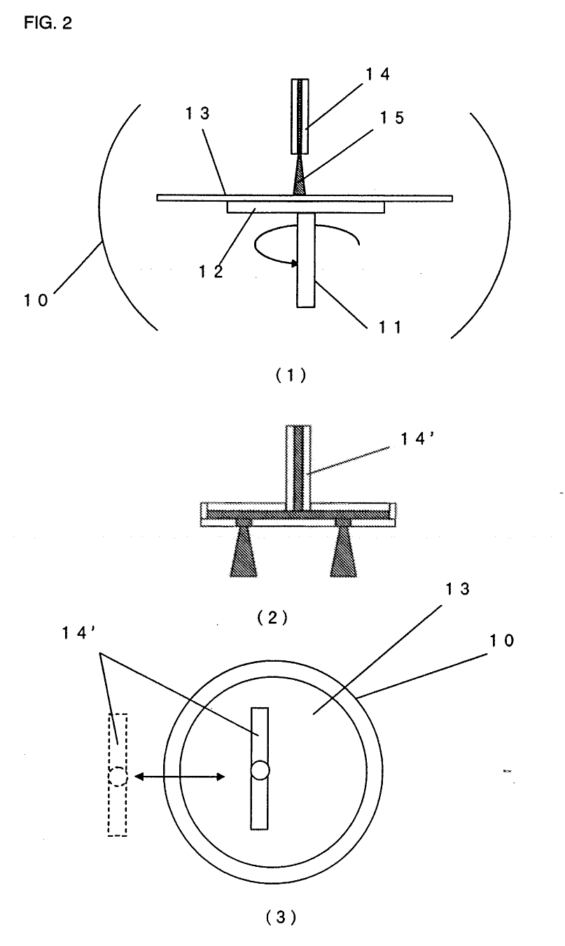

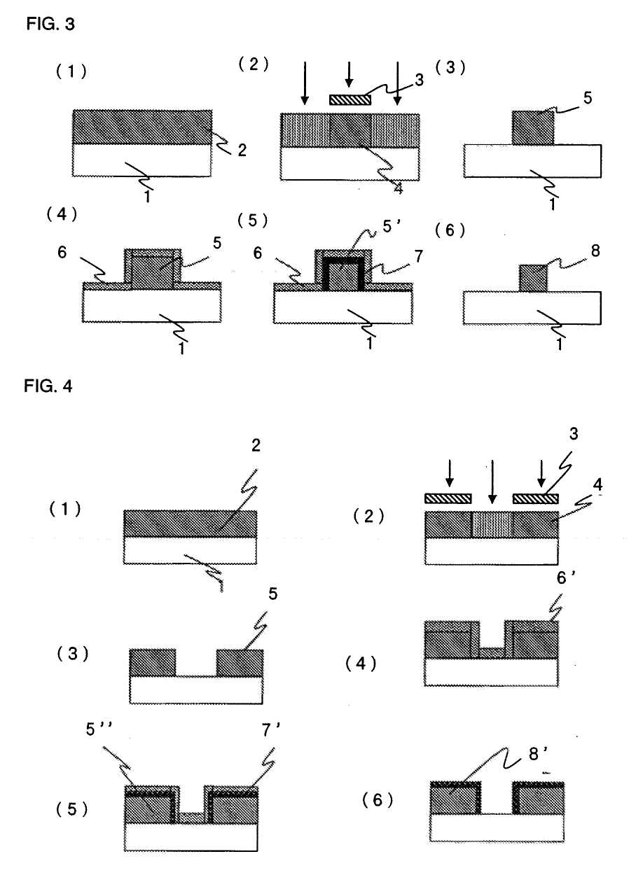

In the present embodiment, a resist pattern reduction material is applied on a substrate by an application apparatus whose basic structure is the same as that of the application apparatus shown in FIG. 2. In the application apparatus shown in FIG. 2, the nozzle for applying a photoresist and the nozzle for washing have different shapes each other. In the similar manner, in the present embodiment, a first nozzle for dropping the resist pattern reduction material has a plurality of openings arranged in a row. The plurality of openings are arranged such that the openings traverse substantially a center of the substrate. A distance L across the arranged openings and a diameter R of the substrate satisfy a relation of 0.8R≦L≦R. Further, the application apparatus has a temperature raising means for raising a temperature of the resist pattern reduction material in the vicinity of the openings, and has a second nozzle for supplying a remover liquid for removing the resist pattern reduction material on the substrate and the transformed layer on a surface of the resist pattern which has been transformed by the resist pattern reduction material. The second nozzle for supplying the remover liquid may be the same as the one used for washing.

Thus, the application apparatus has the first nozzle for dropping the resist pattern reduction material, and the second nozzle for dropping the solution for removing the excessive resist pattern reduction material and the transformed layer of the resist pattern. Accordingly, a single application apparatus can be used both for transforming the resist pattern and for removing the excessive resist pattern reduction material and the transformed layer of the resist pattern. Further, the application apparatus can make a temperature of the resist pattern reduction material for transforming the resist pattern raised in the vicinity of the nozzle openings. Accordingly, by using the application apparatus of the present embodiment, the step for conveying a substrate out of back to the application apparatus can be eliminated, and also the necessity for further providing such an apparatus as a hot plate can be eliminated, whereas by the conventional method, a substrate is conveyed out of the application apparatus for heating by a hot plate or the like so as to accelerate transformation of the resist pattern, and then conveyed back to the application apparatus for removing the excessive resist pattern reduction material and the transformed layer of the resist pattern.

The temperature of the resist pattern reduction material may be preferably raised to the reaction promoted temperature. The reaction promoted temperature is usually higher than the room temperature (which is typically 25° C.).

Because a temperature of the substrate is usually at ordinary temperature (which is typically 25° C.), the temperature should preferably be raised up, in advance, to the same temperature as that of the resist pattern reduction material. Increase of the substrate temperature can be readily achieved by, for example, providing a heating apparatus such as a heater at a substrate mounting table. More preferably, a heating apparatus such as a Peltier element which is capable of both heating and cooling may be used, so that the substrate can be cooled to decrease a reaction rate after heating time.

The method for forming the reduced resist pattern of the present embodiment is different from the conventional technique in that a temperature of a resist pattern reduction material is raised in advance according to the subsequent reduction ratio (or line width) of the material. If the resist pattern reduction material is heated at a portion where the resist pattern reduction material is stored, acidity and concentration of the resist pattern reduction material are varied, leading to variation in an amount of an alkali-soluble portion which surface of alkali-insoluble resist pattern is turned to using the resist pattern reduction material. Therefore, the temperature of the resist pattern reduction material is required to be raised just before the resist pattern reduction material is dropped onto the substrate.

Hereinafter is described the present embodiment in detail with reference to the drawings. The application apparatus used in the present embodiment can be substantially the same as the apparatus described referring to FIG. 2 to 2. Therefore, it is not necessary to manufacture a completely novel application apparatus, but a simple modification may be made to a conventional applying apparatus.

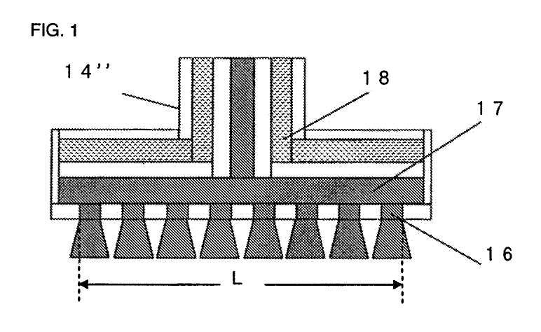

A nozzle used for applying a resist pattern reduction material in the present embodiment is shown in detail in FIG. 1.

FIG. 1 is a schematic cross sectional view of an example of a nozzle used for applying a resist pattern reduction material. A nozzle 14″ of FIG. 1 is of a double structure, in which a heating medium 18 is provided, via a wall surface, outside a portion where a resist pattern reduction material 17 is supplied. A plurality of openings 16 arranged linearly are provided to the nozzle 14″ so as to have the equivalent length as a diameter of a substrate. When a diameter of the substrate is R, a distance L across the openings may preferably be 0.8R≦L≦R, more preferably 0.85R≦L≦0.95R.

If the distance L across the openings is larger than R, the resist pattern reduction material is dropped outside the substrate to contaminate a cup, and further to waste the resist pattern reduction material. On the contrary, if the distance L across the openings is lower than 0.80R, supply of the resist pattern reduction material to an outer peripheral portion of the substrate is delayed compared to the supply to a central portion of the substrate. Since the temperature of the resist pattern reduction material has been raised in advance to accelerate reaction, reduction ratio may result in being different between the central portion and the outer peripheral portion of the substrate. When the relation of 0.8R≦L≦R is satisfied, the above problem will not be caused.

Although the resist pattern reduction material is supplied to the plurality of openings from one portion in FIG. 1, it may be supplied from two or more portions.

Although the temperature of the resist pattern reduction material is raised using a heating medium in FIG. 1, the temperature of the resist pattern reduction material may be raised in another way, for example, by placing a heating element such as a heater at a supply side, or using a heat exchanger.

The substrate in which the resist pattern has been formed by completing development is conveyed to a cup. A resist pattern reduction material is then dropped onto the resist pattern formed in the substrate using the nozzle shown in FIG. 1. The temperature of the resist pattern reduction material to be dropped has been raised to that of causing reaction with the resist.

A reaction time depends on the reduction ratio of the resist pattern, a photoresist material, a resist pattern reduction material, and the like. However, since the steps of application, reaction and removal are consecutively performed by a single application apparatus, a reaction time may preferably be 5 minutes or less, more preferably be 3 minutes or less, and much more preferably be around 1 minute, taking into consideration of throughput per unit time of an application apparatus. Conditions that enable completion of reaction within the above reaction time may preferably be selected.

It is preferable to use pure water as the heating medium to prevent contamination of the apparatus when a leakage accident or the like occurs. Since pure water, when it is used, is circulated in a closed condition to bring it to a pressurized state, the temperature of the pure water can be raised to as high as 120° C., and thus will cause no problem.

### EXAMPLES

Hereinafter are described examples for reducing a resist pattern which include a type for reducing a size of resist patterns and a type for reducing a size of spacing between resist patterns, using the apparatus described above. Examples 1 to 6 and Comparative Examples 1 to 3 are those of a type for reducing a size of resist patterns. Examples 11 to 16 and Comparative Examples 11 to 13 are those of a type for reducing a size of spacing between resist patterns.

In each of Examples 1 to 6 and Comparative Examples 1 to 3, a chemically-amplified resist which consists of 100 parts by weight of polyhydroxystyrene with 30% t-butoxy-carbonylation (Mn=10,000), 2 parts by weight of triphenylsulfonium hexafluoroantimonate (acid generator), and 500 parts by weight of ethyl lactate was used as described in Japanese Patent Application Laid-Open No. 2001-281886. The chemically-amplified resist was applied on a substrate and then the substrate was pre-baked on a hot plate at 90° C. for two minutes to form a resist film having a thickness of 0.7 μm. The resultant was exposed using a stepper with a wavelength of 248 nm and was subjected to two-minute PEB on a hot plate at 90° C., followed by one-minute development at 23° C. using an aqueous solution of 2.38 wt % of tetramethylammonium hydroxide. The resultant was then washed with water and dried to obtain a resist pattern having an isolated line with a width of 0.25 μm.

A resist pattern reduction material was applied on the resist pattern to react therewith. The reacted resist pattern and the resist pattern reduction material were then removed using an alkaline developer. Subsequently, a reduction ratio was obtained from the line width of the isolated line measured before and after the step of reducing a resist pattern.

As the resist pattern reduction material, a copolymer C which was polymerized through the procedure described in Japanese Patent Application Laid-Open No. 2001-281886 was used. The copolymer C was conditioned by being homogeneously mixed with pure water so as to contain 50 parts by weight of perfluorooctane sulfonic acid per 100 parts by weight of the copolymer C to obtain an aqueous solution with 10% solid content, followed by filtering using a membrane filter having a pore size of 0.2 μm.

The copolymer C was obtained through the same processes as those disclosed in Japanese Patent Application Laid-Open No. 2001-281886. Specifically, 170 parts of methanol was stocked in a separable flask and subjected to 15-minute bubbling with nitrogen gas, followed by adding 20 parts of 2-acrylamido-2-methylpropane sulfonic acid, 80 parts of 2,2,2-trifluoroethyl acrylate, and 4 parts of 2,2′-azobisisobutyronitrile, and raising the inside temperature up to 60° C. One hour later, the inside temperature was raised up to 80° C. for further reaction for 4 hours, followed by cooling down to 25° C. Subsequently, the resultant was subjected to vacuum drying for removing the solvent, whereby the copolymer C was obtained.

In each of Examples 11 to 16 and Comparative Examples 11 to 13, a resist pattern reduction material consisting of a typical photoresist and a water-soluble resin compound, which is similar to the one disclosed in Japanese Patent Application Laid-Open No.10-73927, was used. Specifically, GKR-5315D7 made by FUJIFILM Electronic Materials Co., Ltd. was used as a photoresist, and AZ R200 made by AZ Materials was used as a resist pattern reduction material to form an opening having a diameter Φ 100 nm. The diameter of the opening before and after the step of reducing a resist pattern was measured to obtain a reduction ratio of a size of spacing between resist patterns.

### Example 1

The resist pattern reduction material, whose temperature had been raised up to 85° C., was dropped on the resist pattern in a state where the substrate was at ordinary temperature. The substrate was rotated for 15 seconds at 1500 rounds per minute for uniformly applying the material. The substrate was thereafter rotated for 45 seconds (reaction time) at 100 rounds per minute. Then, the resist pattern reduction material and a transformed layer formed on the resist pattern were removed using an alkaline developer.

### Example 2

The resist pattern was reduced in the same manner as in Example 1 except that the rotating time of the substrate (reaction time) was set to 60 seconds.

### Example 3

The resist pattern was reduced in the same manner as in Example 1 except that the rotating time of the substrate (reaction time) was set to 75 seconds.

### Example 4

The resist pattern was reduced in the same manner as in Example 1 except that, after raising the substrate temperature up to 90° C., the resist pattern reduction material, whose temperature had been raised up to 90°C., was dropped.

### Example 5

The resist pattern was reduced in the same manner as in Example 2 except that, after raising the substrate temperature up to 90° C., the resist pattern reduction material, whose temperature had been raised up to 90° C., was dropped.

### Example 6

The resist pattern was reduced in the same manner as in Example 3 except that, after raising the substrate temperature up to 90° C., the resist pattern reduction material, whose temperature had been raised up to 90° C., was dropped.

### Comparative Example 1

The resist pattern reduction material of ordinary temperature was dropped on the resist pattern in a state where the substrate was at ordinary temperature. The substrate was rotated for 5 seconds at 1500 rounds per minute so that the resist pattern reduction material covers the substrate with a uniform thickness. The substrate was then conveyed onto a hot plate which had been heated up to 90° C. and the substrate was retained for 45 seconds. The substrate was then conveyed back to the application apparatus to remove the resist pattern reduction material and a transformed layer formed on the resist pattern using an alkaline developer as in Example 1.

### Comparative Example 2

The resist pattern was reduced in the same manner as in Comparative Example 1 except that the time for retaining the substrate on the hot plate was 60 seconds.

### Comparative Example 3

The resist pattern was reduced in the same manner as in Comparative Example 1 except that the time for retaining the substrate on the hot plate was 75 seconds.

### Example 11

The resist pattern reduction material, whose temperature had been raised up to 110° C., was dropped on the resist pattern in a state where the substrate was at ordinary temperature. The substrate was rotated for 15 seconds at 1500 rounds per minute for uniformly applying the material. The substrate was thereafter rotated for 45 seconds (reaction time) at 100 rounds per minute. Then, the resist pattern reduction material was removed by washing with water.

### Example 12

The resist pattern was reduced in the same manner as in Example 11 except that the rotating time of the substrate (reaction time) was set to 60 seconds.

### Example 13

The resist pattern was reduced in the same manner as in Example 11 except that the rotating time of the substrate (reaction time) was set to 75 seconds.

### Example 14

The resist pattern was reduced in the same manner as in Example 11 except that, after raising the substrate temperature up to 110° C., the resist pattern reduction material, whose temperature had been raised up to 110° C., was dropped.

### Example 15

The resist pattern was reduced in the same manner as in Example 12 except that, after raising the substrate temperature up to 110° C., the resist pattern reduction material, whose temperature had been raised up to 110° C., was dropped.

### Example 16

The resist pattern was reduced in the same manner as in Example 13 except that, after raising the substrate temperature up to 110° C., the resist pattern reduction material, whose temperature had also been raised up to 110° C., was dropped.

### Comparative Example 11

The resist pattern reduction material of ordinary temperature was dropped on the resist pattern in a state where the substrate was at ordinary temperature. The substrate was rotated for 15 seconds at 1500 rounds per minute so that the resist pattern reduction material covers the substrate with a uniform thickness. The substrate was then conveyed onto a hot plate which had been heated up to 110° C. and the substrate was retained for 45 seconds. The substrate was then conveyed back to the application apparatus to remove the resist pattern reduction material by washing with water as in Example 1 1.

### Comparative Example 12

The resist pattern was reduced in the same manner as in Comparative Example 11 except that the time for retaining the substrate on the hot plate was 60 seconds.

### Comparative Example 13

The resist pattern was reduced in the same manner as in Comparative Example 11 except that the time for retaining the substrate on the hot plate was 75 seconds.

It should be appreciated that ordinary temperature is 25° C.

TABLE 1

| | | | temperature of | | | |
|---|---|---|---|---|---|---|
| | | | pattern reduction | temperature of | | reduction |
| | | pattern reduction | material | substrate | time | ratio |
| | photo-resist | material | (° C.) | (° C.) | (sec) | (μm) |
| Ex. 1 | chemically- | copolymer C + | 90 | 25 | 45 | 0.013 |
| Ex. 2 | amplified | perfluorooctance | 90 | 25 | 60 | 0.018 |
| Ex. 3 | resist*¹ | sulfonic acid | 90 | 25 | 75 | 0.023 |
| Ex. 4 | | | 90 | 25 | 45 | 0.015 |
| Ex. 5 | | | 90 | 25 | 60 | 0.020 |
| Ex. 6 | | | 90 | 25 | 75 | 0.025 |
| | | | baking temperature (° C.) | | | |
| Comp. | | | 90 | | 45 | 0.015 |
| Ex. 1 | | | | | | |
| Comp. | | | 90 | | 60 | 0.020 |
| Ex. 2 | | | | | | |
| Comp. | | | 90 | | 75 | 0.025 |
| Ex. 3 | | | | | | |
| Ex. 11 | GKR | AZ R200 | 110 | 25 | 45 | 21 |
| Ex. 12 | 5315D7 | | 110 | 25 | 60 | 29 |
| Ex. 13 | | | 110 | 25 | 75 | 38 |
| Ex. 14 | | | 110 | 110 | 45 | 30 |
| Ex. 15 | | | 110 | 110 | 60 | 40 |
| Ex. 16 | | | 110 | 110 | 75 | 50 |

| | baking temperature (° C.) | | |
|---|---|---|---|
| Comp. | 110 | 45 | 30 |
| Ex. 11 | | | |
| Comp. | 110 | 60 | 40 |
| Ex. 12 | | | |
| Comp. | 110 | 75 | 50 |
| Ex. 13 | | | |

*¹chemically-amplified resist which consists of 100 parts by weight of polyhydroxystyrene with 30% t-butoxy-carbonylation (Mn = 10,000), 2 parts by weight of triphenylsulfonium hexafluoroantimonate (acid generator), and 500 parts by weight of ethyl lactate.

As shown in Table 1, a pattern reduction is achieved in all of the above Examples and Comparative Examples. Reduction ratios in Examples 4 to 6, and Examples 14 to 16, in each of which substrate temperature was raised, are larger than those in Examples 1 to 3, and Examples 11 to 13, in each of which substrate was at ordinary temperature, but no problematic difference can be seen.

Further, Examples 1 to 6, and 11 to 16 provide substantially the same results as those of Comparative Examples 1 to 3, and 11 to 13 where the same methods for reducing as in the prior art were used. As can be seen from this result, the above Examples are sufficiently usable.

While the invention has been described in its preferred embodiments, it is to be understood that the invention is not particularly limited to these embodiments and various changes and modifications may be made in the invention without departing from the spirit and scope thereof.

What is claimed is:

1. A method for forming a resist pattern, comprising the steps of:
conveying a substrate, on which the resist pattern with a first size is formed, to a substrate mounting table of an application apparatus;
raising a temperature of a resist pattern reduction material supplied to the application apparatus in the vicinity of an opening of a nozzle for dropping the resist pattern reduction material in the application apparatus;
dropping the temperature-raised resist pattern reduction material onto the resist pattern of the substrate to be applied;
forming the transformed layer between the resist pattern and the applied resist pattern reduction material; and
reducing the resist pattern to that with a second size by removing the resist pattern reduction material,
wherein the steps of from conveying the substrate to reducing the resist pattern are performed without transferring the substrate out of the application apparatus.

2. The method for forming a resist pattern according to claim 1, further comprising a step of raising a temperature of the substrate conveyed to the substrate mounting table of the application apparatus to the same temperature as that of the temperature-raised resist pattern reduction material, prior to the step of dropping the resist pattern reduction material.

3. The method for forming a resist pattern according to claim 1, wherein in the step of raising the temperature of the resist pattern reduction material, the temperature is raised to the reaction promoted temperature which is higher than the room temperature.

4. An application apparatus for forming a resist pattern which reduces the resist pattern, comprising:
a substrate mounting table integrated with a rotating shaft for mounting a substrate thereon;
a rotation means for rotating the substrate mounted on the substrate mounting table by rotating the rotating shaft;
a first nozzle for dropping the resist pattern reduction material onto the substrate;
a cup extending along the axial direction of the rotating shaft so as to cover at least the substrate and the rotating shaft,
a temperature raising means for raising a temperature of the resist pattern reduction material in the vicinity of the openings; and
a second nozzle for supplying a remover liquid for removing the resist pattern reduction material on the substrate;
wherein the first nozzle for dropping the resist pattern reduction material onto the substrate has a plurality of openings arranged in a row;
the plurality of openings are arranged such that the plurality of openings traverse substantially a center of the substrate mounted on the substrate mounting table; and
a distance L across the plurality of openings and a diameter R of the substrate satisfy a relation of 0.8R≦L≦R.
